(19) United States
(12) Patent Application Publication
(10) Pub. No.: US 2025/0116908 A1
(43) Pub. Date: Apr. 10, 2025

(54) LARGE-AREA ELECTRO-OPTIC LIGHT MODULATOR OR DISPLAY

(71) Applicant: E INK CORPORATION, Billerica, MA (US)

(72) Inventors: Stephen J. TELFER, Arlington, MA (US); Michael LIS, North Andover, MA (US); Yu XIA, Acton, MA (US)

(21) Appl. No.: 18/829,916

(22) Filed: Sep. 10, 2024

Related U.S. Application Data
(60) Provisional application No. 63/542,880, filed on Oct. 6, 2023.

(51) Int. Cl. G02F 1/16755; G02F 1/167; G02F 1/1675

(52) U.S. Cl. CPC G02F 1/16755; G02F 1/167; G02F 2001/1678

(57) ABSTRACT

A large-area switchable electro-optic light modulator or display and method of manufacture are disclosed. The large-area light modulator comprises an array of individual light modulator units sandwiched between two larger light-transmissive substrates coated on their inner surfaces with light-transmissive electrode layers with electrical connections to each unit that do not compromise the transparency of the light modulator in an open state. The large-area display comprises an array of individual display units. A large-area light-transmissive substrate coated on its inner surface with a light-transmissive electrode layer is superposed on the individual display units with electrical connections to each unit that do not compromise the transparency of the display. The light modulator and the display can be readily manufactured using conventional equipment.

### RELATED APPLICATIONS

This application claims priority to U.S. Provisional Patent Application No. 63/542,880 filed on Oct. 6, 2023 entitled LARGE-AREA ELECTRO-OPTIC LIGHT MODULATOR OR DISPLAY, which is incorporated herein by reference in its entirety.

### BACKGROUND

The present application generally relates to electrophoretic and other electro-optic displays and light modulating films. The light modulating films modulate the amount of light or other electro-magnetic radiation passing through an electrophoretic medium. In some instances, the light will pass completely through the film (i.e., from top to bottom). In other instances, the light may pass through the electrophoretic medium, reflect/scatter off a surface, and return through the medium a second time (i.e., from top to bottom surfaces and back to top.) In other instances, the light will be absorbed by pigment particles present at the viewing surface. In other instances, selective absorption of the light by pigment particles will result in a rendered image, e.g., text or a picture. Such films can be incorporated into displays, signs, variable transmission windows, mirrors, displays, and similar devices. Typically the films have an “open” state, in which one or more sets of pigment particles are isolated to the side or in wells, etc., so that most of the incident light can pass through the medium, and a “closed” state, in which one or more sets of pigment particles are distributed through the medium to absorb some or all of the incident light.

For example, U.S. Pat. No. 10,067,398 discloses an electrophoretic light attenuator comprising a cell including a first substrate, a second substrate spaced apart from the first substrate, a layer arranged between the substrates containing an electrophoretic ink, and a monolayer of closely packed protrusions projecting into the electrophoretic ink and arranged adjacent a surface of the second substrate. The protrusions have surfaces defining a plurality of depressions between adjacent protrusions. The electrophoretic medium layer (ink layer) includes charged particles of at least one type, the particles being responsive to an electric field applied to the cell to move between a first extreme light state, in which the particles are maximally spread within the cell so as to lie in the path of light through the cell and thus strongly attenuate light transmitted from one substrate to the opposite substrate, and a second extreme light state, in which the particles are maximally concentrated within the depressions so as to let light be transmitted. The total area corresponding to the concentrated particles in the depressions is a fraction of the total face area.

Devices of this type rely at least in part on the shape of their non-planar, polymer structure to concentrate absorbing charged particles (e.g., black particles) in an electrophoretic ink in a transparent light state thereby forming (or exposing) light apertures (i.e., transmitting areas) and light obstructions (i.e., strongly absorbing areas). The present application additionally relates to more traditional electrophoretic displays, such as described in U.S. Pat. Nos. 9,921,451 and 9,812,073, which modulate the light reflected at the viewing surface with the presence of charged pigment particles.

For convenience, the term “light” will normally be used herein, but this term should be understood in a broad sense to include electro-magnetic radiation at non-visible wavelengths. For example, as the present invention may be applied to provide windows that can modulate infra-red radiation for controlling temperatures within buildings or vehicles. More specifically, this invention relates to light modulators that use particle-based electrophoretic media to control light modulation. Examples of electrophoretic media that may be incorporated into various embodiments of the present invention include, e.g., the electrophoretic media described in U.S. Pat. Nos. 10,809,590 and 10,983,410, the contents of both of which are incorporated by reference herein in their entireties.

Prior art solutions that have a polymer structure in the fluid or gel layer suitable for use with the invention include U.S. Pat. No. 8,508,695 to Vlyte Innovations Ltd., which discloses dispersing fluid droplets (1 to 5 microns in diameter) in a continuous polymer matrix that is cured in place to both substrates, to contain liquid crystals. Additionally, U.S. Pat. No. 10,809,590 to E Ink Corporation discloses microencapsulating fluid droplets and deforming them to form a monolayer of close packed polymer shells in a polymer matrix on one substrate and subsequently applying an adhesive layer to bond the capsule layer to a substrate. Also, European Patent Application Publication EP1264210 to E Ink California discloses embossing a micro-cup structure on one substrate, filling the cups with fluid having polymerizable components and polymerizing the components to form a sealing layer on the fluid/cup surface, then applying an adhesive layer to bond to the second substrate. Additionally, EP2976676 to Vlyte Innovations Ltd. discloses forming a wall structure on one substrate, coating the tops of walls with adhesive, filling the cavities defined by the walls with fluid, and polymerizing the adhesive to bond the tops of walls to the opposing substrate. EP3281055 describes a flexible device including solid polymer microstructures embedded in its viewing area and the microstructures are on both substrates. The microstructures join (i.e., fasten) the substrates of the device to each other by engaging with each other over a length orthogonal to the substrates. The joined microstructures incorporate a wall structure that divides a device's fluid layer into a monolayer of discrete volumes contained within corresponding cavities. This provides the device with significant structural strength. In the method described, mating microstructures (i.e., male and female parts) are formed on each substrate, then precisely aligned with each other and joined in a press fit that also seals the fluid layer in the cavities.

Particle-based electrophoretic displays, in which a plurality of charged particles move through a suspending fluid under the influence of an electric field, have been the subject of intense research and development for a number of years. Such displays can have attributes of good brightness and contrast, wide viewing angles, state bistability, and low power consumption when compared with liquid crystal displays. The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, e.g., at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

As noted above, electrophoretic media require the presence of a suspending fluid. In most prior art electrophoretic media, this suspending fluid is a liquid, but electrophoretic media can be produced using gaseous suspending fluids; see, e.g., Kitamura, T., et al., “Electrical toner movement for electronic paper-like display”, IDW Japan, 2001, Paper HCS1-1, and Yamaguchi, Y, et al., “Toner display using insulative particles charged triboelectrically”, IDW Japan, 2001, Paper AMD4-4). See also European Patent Applications 1,429,178; 1,462,847; and 1,482,354; and International Applications WO 2004/090626; WO 2004/079442; WO 2004/077140; WO 2004/059379; WO 2004/055586; WO 2004/008239; WO 2004/006006; WO 2004/001498; WO 03/091799; and WO 03/088495. Such gas-based electrophoretic media appear to be susceptible to the same types of problems due to particle settling as liquid-based electrophoretic media, when the media are used in an orientation that permits such settling, e.g., in a sign where the medium is disposed in a vertical plane. Indeed, particle settling appears to be a more serious problem in gas-based electrophoretic media than in liquid-based ones since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation, E Ink California, LLC, and related companies describe various technologies used in encapsulated and microcell electrophoretic and other electro-optic media. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. The technologies described in these patents and applications include:
(a) Electrophoretic particles, fluids and fluid additives; see, e.g., U.S. Pat. Nos. 7,002,728 and 7,679,814;
(b) Capsules, binders and encapsulation processes; see, e.g., U.S. Pat. Nos. 6,922,276 and 7,411,719;
(c) Microcell structures, wall materials, and methods of forming microcells; see for example U.S. Pat. Nos. 7,072,095 and 9,279,906;
(d) Methods for filling and sealing microcells; see, e.g., U.S. Pat. Nos. 7,144,942 and 7,715,088;
(e) Films and sub-assemblies containing electro-optic materials; see, e.g., U.S. Pat. Nos. 6,982,178 and 7,839,564;
(f) Backplanes, adhesive layers and other auxiliary layers and methods used in displays; see, e.g., U.S. Pat. Nos. 7,116,318 and 7,535,624;
(g) Color formation and color adjustment; see, e.g., U.S. Pat. Nos. 7,075,502 and 7,839,564;
(h) Methods for driving displays; see, e.g., U.S. Pat. Nos. 7,012,600 and 7,453,445;
(i) Applications of displays; see, e.g., U.S. Pat. Nos. 7,312,784 and 8,009,348; and
(j) Non-electrophoretic displays, as described in U.S. Pat. No. 6,241,921 and U.S. Patent Applications Publication No. 2015/0277160; and applications of encapsulation and microcell technology other than displays; see, e.g., U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see, e.g., the aforementioned U.S. Patent Application Publication No. 2002/0131147. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the charged particles and the suspending fluid are not encapsulated within microcapsules, but instead are retained within a plurality of cavities formed within a carrier medium, typically a polymeric film. See, e.g., International Application Publication No. WO 02/01281, and published U.S. Application Publication No. 2002/0075556, both assigned to SiPix Imaging, Inc.

Electrophoretic media are often opaque (since, e.g., in many electrophoretic media, the particles substantially block transmission of visible light through the display) and operate in either a light-absorptive or a light-reflective mode. However, electrophoretic devices can also be made to operate in a so-called “shutter mode,” in which one display state is substantially opaque and one is substantially light-transmissive. See, e.g., the aforementioned U.S. Pat. Nos. 6,130,774 and 6,172,798, and 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. In particular, when this “shutter mode” electrophoretic device is constructed on a transparent substrate, it is possible to regulate transmission of light through the device.

An encapsulated or microcell electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition; and other similar techniques.) Thus, the resulting display can be flexible. Further, because the display medium can be printed (using a variety of methods), the display itself can be made inexpensively.

One potentially important market for electrophoretic media is windows with variable light transmission. As the energy performance of buildings becomes increasingly important, electrophoretic media could be used as coatings on windows to enable the proportion of incident radiation transmitted through the windows to be electronically controlled by varying the optical state of the electrophoretic media. Effective implementation of such “variable-transmissivity” (“VT”) technology in buildings is expected to provide (1) reduction of unwanted heating effects during hot weather, thus reducing the amount of energy needed for cooling, the size of air conditioning plants, and peak electricity demand; (2) increased use of natural daylight, thus reducing energy used for lighting and peak electricity demand; and (3) increased occupant comfort by increasing both thermal and visual comfort. Even greater benefits would be expected to accrue in an automobile or other vehicle, where the ratio of glazed surface to enclosed volume is significantly larger than in a typical building. Specifically, effective implementation of VT technology in automobiles is expected to provide not only the aforementioned benefits but also (1) increased motoring safety, (2) reduced glare, (3) enhanced mirror performance (by using an electro-optic coating on the mirror), and (4) increased ability to use heads-up displays. Other potential applications of VT technology include privacy glass and glare-guards in electronic devices.

Many switchable electrophoretic light modulator applications and electrophoretic display applications require coverage of large areas. For example, the modulators may be used in office building windows that are several meters by several meters in area, or the electrophoretic display may be a wide format sign, having a diagonal measurement of greater than 1 meter. One factor limiting manufacturing of such large modulators/displays is the difficulty of manufacturing large-area polymer structures used in the modulators/displays to concentrate charged particles in the open state. Typically, the polymer structures are manufactured using embossing drums, which often have a width of one meter or less, which limits the size of the structures that can be formed from the final polymer structures. While, it is possible to combine several small-area light modulator units in an array for large window applications, it is difficult to make electrical connections to individual units that are not at the edges of the array without compromising the optical transparency of the light modulator in the open state, particularly since electrical connections need to be made on both sides of each unit. Thus, a need exists for a large-area light modulator/display that does not compromise optical transparency and can be readily manufactured using conventional equipment.

### SUMMARY

A large-area electro-optic device includes a plurality of electro-optic units in a side-by-side tiled arrangement. Each of the electro-optic units comprises: (i) a first light-transmissive substrate having opposite inner and outer surfaces, the first light-transmissive substrate having a plurality of electrically-conductive vias extending between the inner and outer surfaces; (ii) a first light-transmissive electrically-conductive layer on the inner surface of the first light-transmissive substrate in electrical contact with the electrically-conductive vias of the first light-transmissive substrate; (iii) a second light-transmissive substrate having opposite inner and outer surfaces, the second light-transmissive substrate having a plurality of electrically-conductive vias extending between the inner and outer surfaces of the second light-transmissive substrate; (iv) a second light-transmissive electrically-conductive layer on the inner surface of the second light-transmissive substrate in electrical contact with the electrically-conductive vias of the second light-transmissive substrate; and (v) an electro-optic medium layer between and in contact with the first and second light-transmissive electrically-conductive layers. The large-area electro-optic device also includes a third light-transmissive substrate superposed on the outer surfaces of the first light-transmissive substrates of each of the plurality of electro-optic units. A third light-transmissive electrically-conductive layer is disposed between the third light-transmissive substrate and the plurality of electro-optic units. The third light-transmissive electrically-conductive layer is in electrical contact with the electrically-conductive vias of the first light-transmissive substrates of each of the plurality of electro-optic units. A fourth light-transmissive substrate is superposed on the outer surfaces of the second light-transmissive substrates of each of the plurality of electro-optic units. A fourth light-transmissive electrically-conductive layer is disposed between the fourth light-transmissive substrate and the plurality of electro-optic units. The fourth light-transmissive electrically-conductive layer is in electrical contact with the electrically-conductive vias of the second light-transmissive substrates of each of the plurality of electro-optic units.

A method of manufacturing an electro-optic device includes the steps of: (a) providing a plurality of electro-optic units; (b) positioning the plurality of electro-optic units in a side-by-side tiled arrangement; and (c) laminating a third light-transmissive substrate covered by a third light-transmissive electrically-conductive layer on one side of the plurality of electro-optic units and a fourth light-transmissive substrate covered by a fourth light-transmissive electrically-conductive layer on an opposite side of the plurality of electro-optic units. Each of the electro-optic units comprises (i) a first light-transmissive substrate having opposite inner and outer surfaces, the first light-transmissive substrate having a plurality of electrically-conductive vias extending between the inner and outer surfaces; (ii) a first light-transmissive electrically-conductive layer on the inner surface of the first light-transmissive substrate in electrical contact with the electrically-conductive vias of the first light-transmissive substrate; (iii) a second light-transmissive substrate having opposite inner and outer surfaces, the second light-transmissive substrate having a plurality of electrically-conductive vias extending between the inner and outer surfaces of the second light-transmissive substrate; (iv) a second light-transmissive electrically-conductive layer on the inner surface of the second light-transmissive substrate in electrical contact with the electrically-conductive vias of the second light-transmissive substrate; and (v) an electro-optic medium layer between and in contact with the first and second light-transmissive electrically-conductive layers. The third light-transmissive substrate is superposed on the outer surfaces of the first light-transmissive substrates of each of the plurality of electro-optic units, and the third light-transmissive electrically-conductive layer is disposed between the third light-transmissive substrate and the plurality of electro-optic units. The third light-transmissive electrically-conductive layer is in electrical contact with the electrically-conductive vias of the first light-transmissive substrates of each of the plurality of electro-optic units. The fourth light-transmissive substrate is superposed on the outer surfaces of the second light-transmissive substrates of each of the plurality of electro-optic units, and the fourth light-transmissive electrically-conductive layer is disposed between the fourth light-transmissive substrate and the plurality of electro-optic units. The fourth light-transmissive electrically-conductive layer is in electrical contact with the electrically-conductive vias of the second light-transmissive substrates of each of the plurality of electro-optic units.

An electro-optic device includes a plurality of electro-optic units in a side-by-side tiled arrangement. Each of the electro-optic units comprises, in order: (i) a first light-transmissive substrate having opposite inner and outer surfaces, the first light-transmissive substrate having a plurality of electrically-conductive vias extending between the inner and outer surfaces; (ii) a first light-transmissive electrically-conductive layer on the inner surface of the first light-transmissive substrate in electrical contact with the electrically-conductive vias of the first light-transmissive substrate; (iii) an electro-optic medium layer in contact with the first light-transmissive electrically-conductive layer; and (iv) a backplane comprising at least one electrode. A second light-transmissive substrate is superposed on the outer surfaces of the first light-transmissive substrates of each of the plurality of electro-optic units. A second light-transmissive electrically-conductive layer is between the second light-transmissive substrate and the plurality of electro-optic units. The second light-transmissive electrically-conductive layer is in electrical contact with the electrically-conductive vias of the first light-transmissive substrates of each of the plurality of electro-optic units.

These and other aspects of the present invention will be apparent in view of the following description.

### BRIEF DESCRIPTION OF THE DRAWINGS

Embodiments of the invention will now be described, by way of example, with reference to the accompanying drawings, in which:

FIG. 1 is a simplified diagram illustrating an exemplary switchable electrophoretic light modulator unit.

FIG. 2A is a perspective view of a portion of an exemplary polymeric structure forming part of an electrophoretic ink layer of the light modulator unit.

FIG. 2B is a simplified cross-sectional view of a portion of the light modulator unit showing the device in a “closed” state in which the charged pigment particles are distributed across the cells of the device and absorb incident light.

FIG. 2C is a simplified cross-sectional view of a portion of the light modulator unit in an “open” state in which the charged pigment particles concentrate in wells of the polymeric structure of the device.

FIGS. 3A and 3B are cross-sectional and top plan views, respectively, of another light modulator unit in an open state.

FIG. 4 is a simplified exploded view of an exemplary large-area light modulator assembled from an array of individual light modulator units in accordance with one or more embodiments.

FIG. 5 is a simplified cross-section view of an exemplary individual light modulator unit in accordance with one or more embodiments.

FIG. 6 is a simplified perspective view of an electrophoretic display having a substrate with an array of vias in accordance with the prior art.

FIG. 7 is a simplified cross-section view of a portion of an exemplary large-area light modulator in accordance with one or more embodiments.

FIG. 8A-8C show simplified cross-section views illustrating an exemplary process of forming a light-transmissive substrate with a light-transmissive electrically-conductive layer for use in a light modulator unit in accordance with one or more embodiments.

FIG. 9 is a simplified cross-section view illustrating an exemplary process of forming a light modulator unit in accordance with one or more embodiments.

FIG. 10 is a simplified exploded view of an exemplary large-area display assembled from an array of individual display units in accordance with one or more embodiments.

FIG. 11 is a simplified diagram illustrating an exemplary process for producing a display unit in accordance with one or more embodiments.

The drawing depict one or more implementations in accord with the present concepts, by way of example only, not by way of limitations.

### DETAILED DESCRIPTION

Various embodiments disclosed herein relate to a large-area switchable electro-optic light modulator and method of manufacture. The large-area light modulator comprises an array of individual light modulator units sandwiched between two larger light-transmissive substrates coated on their inner surfaces with light-transmissive electrode layers with electrical connections to each unit that do not compromise the transparency of the light modulator in an open state. The light modulator can be readily manufactured using conventional equipment.

The light modulating device can be incorporated into a light control device. The light modulator selectively modifies one or more of light transmission, light attenuation, color, specular transmittance, specular reflectance, or diffuse reflectance in response to electrical signals, and switches to provide two or more different light states. In one or more embodiments, a first light state is transparent to visible light and corresponds to a maximum light transmission—a first extreme, i.e., “open” state, and a second light state corresponds to a minimum transmission—a second extreme, i.e., “closed” state. Of course, intermediate states are also possible, known as gray levels. Additionally, depending upon the electrophoretic medium pigment loading, a “closed” state may not be completely opaque, and an “open” state may not be completely transparent. Additionally, if the device is configured for use as a mirror or display, the “open” state may be colored or reflective.

The device utilizes an electro-optic medium such as an electrophoretic ink. The electrophoretic ink comprises colored, charged particles in a suspending fluid and is in contact with the surface of a non-planar, polymer structure. The colored, charged particles can be any color, including black or white. Preferably, the suspending fluid is transparent and refractive index matches the transparent, non-planar, polymer structure for at least one wavelength in the visible spectrum (typically 550 nm), and is a match or near match (i.e., within 0.01) for other visible light wavelengths. Consequently, in the absence of the colored charged particles, visible light rays (for the matched wavelength) experience negligible refraction at the interface between the suspending fluid and the non-planar, polymer structure.

Additionally, the charged pigment particles may be functionalized with surface polymers to improve state stability. Such pigments are described, e.g., in U.S. Pat. No. 9,921,451, which is incorporated by reference in its entirety. For example, if the charged particles are of a white color, they may be formed from an inorganic pigment such as TiO₂, ZrO₂, ZnO, Al₂O₃, Sb₂O₃, BaSO₄, PbSO₄ or the like. They may also be polymer particles with a high refractive index (>1.5) and of a certain size (>100 nm) to exhibit a white color, to be substantially light-transmissive, or composite particles engineered to have a desired index of refraction. Such particles may include, e.g., poly(pentabromophenyl methacrylate), poly(2-vinylnapthalene), poly(naphthyl methacrylate), poly(alphamethylstyrene), poly(N-benzyl methacrylamide) or poly(benzyl methacrylate). Black charged particles may be formed from CI pigment black 26 or 28 or the like (e.g., manganese ferrite black spinel or copper chromite black spinel) or carbon black. Other colors (non-white and non-black) may be formed from organic pigments such as CI pigment PR 254, PR122, PR149, PG36, PG58, PG7, PB28, PB15:3, PY83, PY138, PY150, PY155 or PY20. Other examples include Clariant Hostaperm Red D3G 70-EDS, Hostaperm Pink E-EDS, PV fast red D3G, Hostaperm red D3G 70, Hostaperm Blue B2G-EDS, Hostaperm Yellow H4G-EDS, Novoperm Yellow HR-70-EDS, Hostaperm Green GNX, BASF Irgazine red L 3630, Cinquasia Red L 4100 HD, and Irgazin Red L 3660 HD; Sun Chemical phthalocyanine blue, phthalocyanine green, diarylide yellow or diarylide AAOT yellow. Color particles can also be formed from inorganic pigments, such as CI pigment blue 28, CI pigment green 50, CI pigment yellow 227, and the like. The surface of the charged particles may be modified by known techniques based on the charge polarity and charge level of the particles required, as described in U.S. Pat. Nos. 6,822,782, 7,002,728, 9,366,935, and 9,372,380 as well as U.S. Patent Application Publication No. 2014-0011913, the contents of all of which are incorporated herein by reference in their entireties.

The particles may exhibit a native charge, or may be charged explicitly using a charge control agent, or may acquire a charge when suspended in a solvent or solvent mixture. Suitable charge control agents are well known in the art; they may be polymeric or non-polymeric in nature or may be ionic or non-ionic. Examples of charge control agents include, but are not limited to, Solsperse 17000 (active polymeric dispersant), Solsperse 9000 (active polymeric dispersant), OLOA® 11000 (succinimide ashless dispersant), Unithox 750 (ethoxylates), Span 85 (sorbitan trioleate), Petronate L (sodium sulfonate), Alcolec LV30 (soy lecithin), Petrostep B100 (petroleum sulfonate) or B70 (barium sulfonate), Acrosol OT, polyisobutylene derivatives or poly(ethylene co-butylene) derivatives, and the like. In addition to the suspending fluid and charged pigment particles, internal phases may include stabilizers, surfactants and charge control agents. A stabilizing material may be adsorbed on the charged pigment particles when they are dispersed in the solvent. This stabilizing material keeps the particles separated from one another so that the variable transmission medium is substantially non-transmissive when the particles are in their dispersed state.

As is known in the art, dispersing charged particles (typically a carbon black, as described above) in a solvent of low dielectric constant may be assisted by the use of a surfactant. Such a surfactant typically comprises a polar “head group” and a non-polar “tail group” that is compatible with or soluble in the solvent. The non-polar tail group may be a saturated or unsaturated hydrocarbon moiety, or another group that is soluble in hydrocarbon solvents, such as, e.g., a poly(dialkylsiloxane). The polar group may be any polar organic functionality, including ionic materials such as ammonium, sulfonate or phosphonate salts, or acidic or basic groups. Particularly preferred head groups are carboxylic acid or carboxylate groups. In some embodiments, dispersants, such as polyisobutylene succinimide and/or sorbitan trioleate, and/or 2-hexyldecanoic acid are added.

The dispersion may contain one or more stabilizers. Stabilizers suitable for use in the dispersions made according to the various embodiments of the present invention include, but are not limited to, polyisobutylene and polystyrene. However, only a relatively low concentration of stabilizer may be necessary. A low concentration of stabilizer may assist in maintaining the media in the closed (opaque) or intermediate state, but the size of the hetero-agglomerates of the oppositely charged particles in the open state would be effectively stable without the presence of a stabilizer. For example, the dispersions incorporated in various embodiments may contain, with increasing preference in the amounts listed, less than or equal to 10%, 9%, 8%, 7%, 6%, 5%, 4%, 3%, 2%, and 1% stabilizer based on the weight of the dispersion. In some embodiments, the dispersion may be free of stabilizer.

The fluids used in the variable transmission media in various embodiments will typically be of low dielectric constant (preferably less than 10 and desirably less than 3). The fluids are preferably solvents that have low viscosity, relatively high refractive index, low cost, low reactivity, and low vapor pressure/high boiling point. The fluids are preferably light transmissive and may or may not have an optical property, such as color (e.g., red, green, blue, cyan, magenta, yellow, white, and black), that differs from the optical properties of at least one of the sets of charged particles of the dispersion. Examples of solvents include, but are not limited to, aliphatic hydrocarbons such as heptane, octane, and petroleum distillates such as Isopar® (Exxon Mobil) or Isane® (Total); terpenes such as limonene, e.g., 1-limonene; and aromatic hydrocarbons such as toluene. A particularly preferred solvent is limonene, since it combines a low dielectric constant (2.3) with a relatively high refractive index (1.47). The index of refraction of the internal phase may be modified with the addition of the index matching agents. For example, the aforementioned U.S. Pat. No. 7,679,814 describes an electrophoretic medium suitable for use in a variable transmission device in which the fluid surrounding the electrophoretic particles comprises a mixture of a partially hydrogenated aromatic hydrocarbon and a terpene, a preferred mixture being d-limonene and a partially hydrogenated terphenyl, available commercially as Cargille® 5040 from Cargille-Sacher Laboratories, 55 Commerce Rd, Cedar Grove N.J. 07009. In the encapsulated media made according to various embodiments of the present invention, it is preferred that the refractive index of the encapsulated dispersion match as closely as possible to that of the encapsulating material to reduce haze. In most instances, it is beneficial to have an internal phase with an index of refraction between 1.51 and 1.57 at 550 nm, preferably about 1.54 at 550 nm. In embodiments using a light-transmissive particle that is index matched to the internal phase, the light-transmissive particle will also have an index of refraction between 1.51 and 1.57 at 550 nm, preferably about 1.54 at 550 nm.

In one or more embodiments, the encapsulated fluid may comprise one or more nonconjugated olefinic hydrocarbons, preferably cyclic hydrocarbons. Examples of nonconjugated olefinic hydrocarbons include, but are not limited to, terpenes, such as limonene; phenyl cyclohexane; hexyl benzoate; cyclododecatriene; 1,5-dimethyl tetralin; partially hydrogenated terphenyl, such as Cargille® 5040; phenylmethylsiloxane oligomer; and combinations thereof. A most preferred composition for the encapsulated fluid according to some embodiments comprises cyclododecatriene and a partially hydrogenated terphenyl.

In one or more embodiments, the amount of stabilizing agent included in the encapsulated fluid may be lower than is traditionally used in electrophoretic displays. Sec, for contrast, U.S. Pat. No. 7,170,670. Such stabilizing agents may be large molecular weight free polymers such as polyisobutylene, polystyrene, or poly(lauryl) methacrylate. Accordingly, in some embodiments, the encapsulated fluid (i.e., dispersion) further comprises less than 10% of a stabilizing agent by weight of the dispersion. In some embodiments, the dispersion is free of the stabilizing agent. It is found that by reducing the presence of large molecular-weight polymers, the haze is improved, making the final product more pleasing.

In the first light state of embodiments, the charged particles respond to an electrical field applied to the electrodes to concentrate in volumes defined by the transparent, non-planar, polymer structure.

In some embodiments, the electrophoretic medium is bistable in that the medium can maintain a desired optical state without the application of an electric field. For example, when apertures or obstructions of the first light state are bistable, power can be removed completely (i.e., zero volts between the first and second electrodes) after switching, and the apertures or obstructions remain unchanged. Similarly, the absence of apertures in the second light state, e.g., a light-absorbing or “closed” state is stable after switching and removal of power.

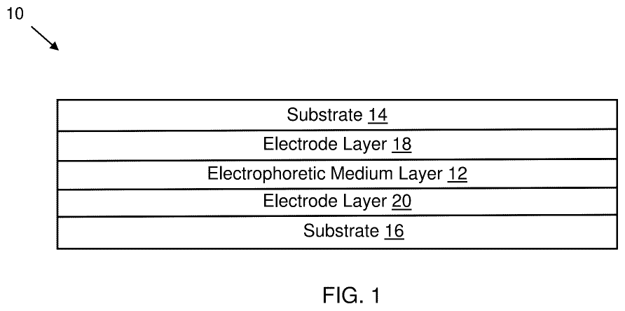

FIG. 1 is a simplified diagram illustrating an exemplary switchable electrophoretic light modulator unit 10. The unit 10 can be assembled with a plurality additional light modulator units 10 in an array to form a large-area light modulator as discussed below. The unit 10 includes an electrophoretic medium layer 12 positioned between a first light-transmissive substrate 14 and a second light-transmissive substrate 16. The major surfaces of the first and second light-transmissive substrates 14, 16 face each other and are juxtaposed parallel.

The first light-transmissive substrate 14 and the second light-transmissive substrate 16 may comprise polymers including acrylate, methacrylate, vinylbenzene, vinylether, or multifunctional epoxides.

A first transparent electrode layer 18 is positioned between the first light-transmissive substrate 14 and the electrophoretic medium layer 12. A second transparent electrode layer 20 is positioned between the second light-transmissive substrate 16 and the electrophoretic layer 12. The electrode layers 18, 20 may each comprise a transparent flexible Polyethylene Terephthalate (PET) film covered on its inner face with a transparent, flexible Indium Tin Oxide (ITO) electrode.

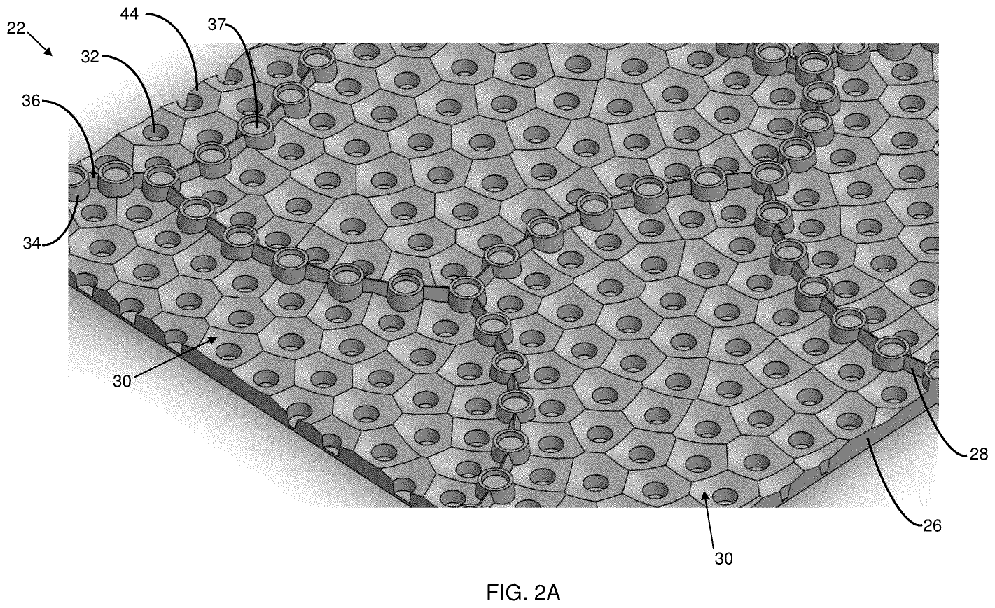

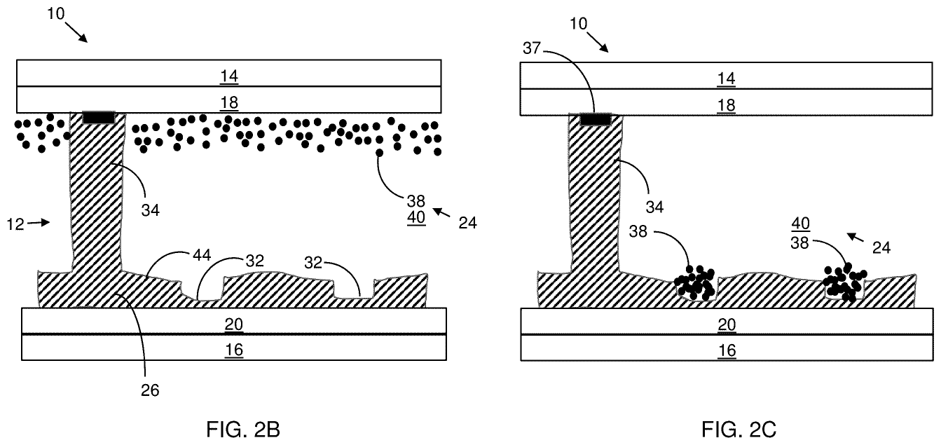

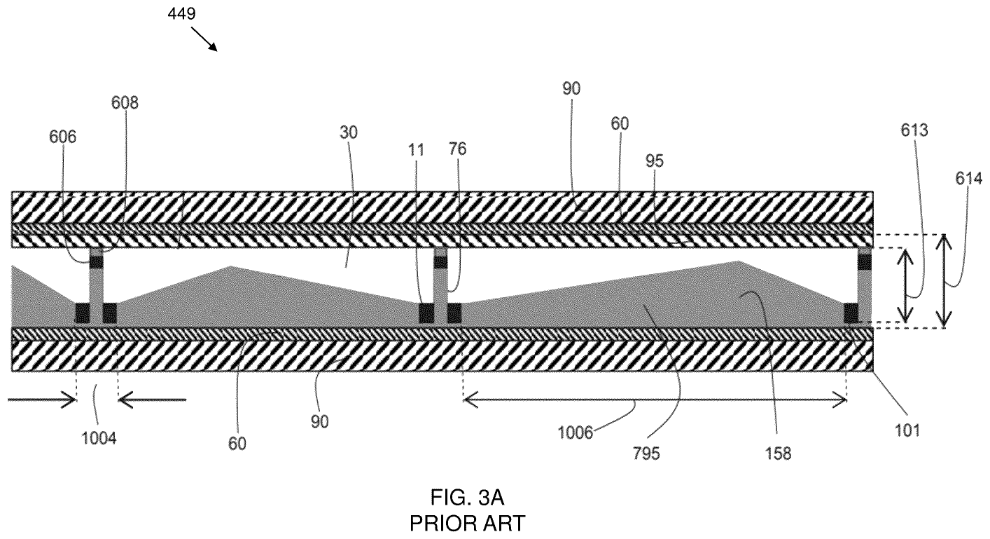

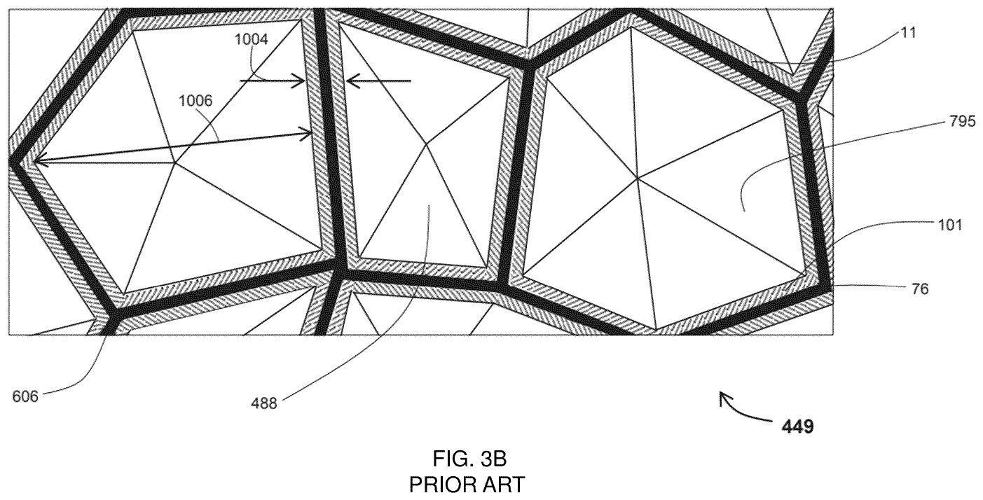

The electrophoretic layer 12 includes a light-transmissive polymeric structure 22 (e.g., as depicted in FIG. 2A or the polymeric structure depicted in FIG. 3A) on the electrode layer 20 and an electro-optic medium 24 contained in cells 30 defined by the polymeric structure 22. The polymeric structure 22 may be formed in an embossing process.

As shown in FIGS. 2B and 2C, the electro-optic medium 24 in the electrophoretic layer 12 comprises charged pigment particles 38 dispersed in a suspending fluid (e.g., a non-polar solvent) 40. The charged particles 38 move through the suspending fluid 40 under the influence of an electric field. As discussed in further detail below, applying a driving voltage between the first and second electrodes 18, 20 causes the electro-optic medium 24 to switch between a first light-absorbing closed state (FIG. 2B) and a second light-transmissive open state (FIG. 2C).

Referring back to FIG. 2A, the exemplary polymeric structure 22 including a base 26 and a wall structure 28 extending from one surface of the base 26. The wall structure 28 defines multiple cells or volumes 30 for receiving and compartmentalizing the electro-optic medium 24. The base 26 of the polymeric structure 22 includes a plurality of wells 32 distributed across each of the cells 30 for receiving and concentrating charged pigment particles 38, thereby limiting the space occupied by the particles 38 in the second light-transmissive state (FIG. 2C). In one or more embodiments, the base 26 includes tapered surfaces 44 leading to each of the wells 32 to promote movement of the particles 38 into the wells 32 in the second light-transmissive state.

The wall structure 28 formed on the base 26 includes a plurality of pillar structures 34 and linking wall elements 36 connecting adjacent pillar structures 34. The pillar structures 34 each include a distal surface 37 parallel to the base 26. The distal surfaces 37 are preferably similar in size and shape to the plurality of wells 32. In one or more embodiments, the distal surfaces 37 of the pillar structures 34 are blackened (or otherwise colored) to resemble the wells 32 of the polymeric structure 22 when filled with pigment particles 38 in the second light-transmissive state.

By contrast, the distal surfaces of the linking wall elements 36 are light-transmissive and not blackened. Because the pillar structures 34 provide substantially all of the structural support and sealing adhesion for the polymeric structure 22, the linking wall elements 36 can have reduced thickness and a small surface area. For example, the total surface area of the linking wall elements 36 can be under 1% of the total area of the polymeric structure 22, so that even without blackened surfaces on the linking wall elements 36, the desired percent transmittance (% T) in the closed state will be within a desired range.

The distal surfaces 37 of the pillars 34 are arranged with the plurality of wells 32 across the surface of the polymeric structure 22 in a pre-determined pattern configured to suppress diffraction when the unit 10 is in the light-transmissive open state. Various algorithms can be used to generate the pattern. In one or more embodiments, the pattern is generated using a blue noise algorithm, a dithering algorithm, a nonrepeating mono-tiles algorithm, an organic inspired algorithm such as phyllotactic spirals, or the like.

The distal surfaces 37 of the pillar structures 34 may be different in size or shape to the wells 32 in order to vary desired optical properties.

The polymeric structure 22 may include additional pillar structures 34 that are free-standing, i.e., separate from the wall structure 28, to provide added structural support for sealing adhesion. Such pillars can be part of the predetermined pattern discussed above generated using a blue noise or other algorithm.

It should be noted that the figures, including FIG. 2A, are not necessarily to scale. In some embodiments, the pitch of the wells 32 and the pillar distal surfaces 37 in the polymeric structure 22 is from 50 microns to 5,000 microns. For example, a smart glass device incorporating the light modulator 10 with a well pitch of 250 microns would typically have between 2,000 and 6,000 wells 32 across its face, and from 2,000 to 20,000 along its face, or a total number in the array of between 4 million and 120 million.

The following two examples show possible approximate dimensions of polymeric structure features.

| Dimension | Example 1 | | Example 2 | |
|---|---|---|---|---|
| Depth of wells | 8 | um | 8 | um |
| Diameter of wells | 11 | um | 15 | um |
| Number of wells per cell | 64 | | 119 | |
| Number of wells in 0.5 m² area | 333,000,000 | | 618,000,000 | |
| Distance from well base to pillar top | 20 | um | 20 | um |
| Average pillar height | 8 | um | 8 | um |
| Linking wall thickness at top | 1 | um | 1 | um |
| Linking wall thickness at base | 15 | um | 15 | um |
| Linking wall height | 8 | um | 8 | um |

FIG. 2B is a cross-sectional view of a portion of the light modulator unit 10 in the dark (closed) state, in which the charged pigment particles 38 in the electro-optic medium 24 are spread across the viewing face and adjacent the inner face of the electrode layer 18. The charged pigment particles 38 absorb light incident on the unit 10.

FIG. 2C shows the light modulator unit 10 in the open state, in which the charged pigment particles 38 are concentrated in the wells 32 of the polymeric structure 22.

The open state forms when a voltage having the opposite polarity to that of the charged particles 38 is applied to the electrode 20 on the substrate 16 to form an electrical field between the opposing electrodes 18, 20. The electrical field drives the charged particles 38 toward the inner face of the substrate 16 and, on encountering the tapered surfaces 44, the particles 38 migrate to and concentrate in the wells 32. The depth of the wells 32 is sufficient to hold the concentrated particles 38 in the open state. It is dependent on the volume needed by the particles 38 to concentrate, and in turn is dependent on the particle loading in the ink's suspending fluid. The latter determines the light transmission in the dark state. The closed state (FIG. 2B) forms when the polarity of the voltage is reversed, attracting the charged particles 38 to the inner face of the substrate 14 where they spread adjacent its electrode 18. The forming of light states in an electrophoretic device using protrusions is described in more detail in the Applicant's U.S. Pat. No. 10,067,398 titled “An Electrophoretic Device Having a Transparent Light State”. It is understood that the charged particles 38 may be driven with time varying voltages, e.g., waveforms that may range in voltage from 0 to +500V, although typically less.

The electro-optic medium 24 and the polymeric structure 22 are preferably optically transparent and a refractive index match. This allows light incident on unit 10, not otherwise absorbed by the pigment particles 38, to be transmitted unhindered (i.e., not refracted or diffracted) by the interface between the suspending fluid of the electro-optic medium 24 and the polymeric structure 22.

A sealing layer having, e.g., a polymeric composition, may be applied over the polymeric structure 22 to seal the electro-optic medium 24 in the plurality of cells 30. The pillar structures 34 provide structural support and sealing adhesion to the sealing layer.

Additionally, one or more layers of adhesive, such as an optically-clear adhesive available, e.g., from Norland, may be used to bond various films and structures to one another.

The cells 30 can be filled with the electro-optic medium 24 in a laminating step that applies the embossed polymer structure 22 previously formed on (and bonded to) the first substrate, to the second substrate, with the electro-optic medium 24 therebetween. Preferably, the laminating step uses a pair of NIP rollers orientated so that the substrates travel from top-to-bottom (as opposed to left-to-right) between the rollers. The fluid is in a bead between the substrates above the NIP point and laminated by the rollers into the cavities in the embossed polymer as the substrates pass the NIP point. The orthogonal distance between the parallel faces of the substrates is determined by the polymer wall structures as the substrates pass the NIP point. Preferably, the tops of the polymer wall are bonded to the second substrate in a UV light (or other radiation) cure stage after or contemporaneously with laminating.

The light modulator may have flexible film substrates and is sufficiently flexible to be compatible with roll-to-roll manufacture. The film device has significant structural strength and compartmentalizes the fluid layer in cavities with each cavity holding a discrete ink volume that is self-scaled and isolated from adjacent cavities. The structural strength of embodiments derives from the selection of its polymer structure and polymer sealing materials. The structural strength includes that necessary to withstand being permanently laminated to glass panes in a laminated safety glass comprising either EVA or PVB interlayers as optical adhesive between the device and glass panes. The device's materials are selected to have resistance to mechanical shocks and environmental extremes (sunlight and outdoor temperature) in normal use.

FIGS. 3A and 3B illustrate a light modulator unit with an alternate polymeric structure as disclosed in U.S. Pat. No. 10,067,398. FIG. 3A shows a cross-section view of the light modulator unit 449, and FIG. 3B shows a top plan view of the polymeric structure 158 of the light modulator unit 449. The polymeric structure 158 is non-planar and comprises protrusions 795 whose extent coincides with channels 101 and cavities 488.

FIGS. 3A and 3B show the light modulator unit in an open state. Black charged particles 11 are deflected by (or move over) the surface of protrusions 795 in an electrical field and concentrate in the interstices of protrusions 795 forming apertures 1006. The non-planar, polymer structure 158 has aperiodically arranged protrusions 795 in electrophoretic cell 614. The surface shape, cross-sectional area, cross-sectional geometric form, and orientation of its protrusions 795 are different from each other and can be random or possess a degree of randomness. Protrusions of the type 795 are asymmetrical and have facets with different areas and slopes to enhance the randomness of the apertures 1006 defined by the protrusions in light states. Light encountering embodiment 449 diffracts randomly and avoids the perception of a diffraction pattern about a bright light source viewed through the device.

Channels 101 coincide with the interstices of protrusions 795 and hold concentrated, black, charged particles 11 in the open state. The channels 101 are recesses in the non-planar, polymer structure 158 and are at least partly below the level of the protrusions 795 as shown in FIG. 3A. In embodiments concentrated black, charged particles fill a volume in the interstices of protrusions proportional to the particle loading in the electrophoretic ink (e.g., a particle loading in the range 5% to 30% by mass of the ink). In viewing a face of the device in the open state, the concentrated particles form light absorbing areas (i.e., obstructions) that limit the maximum light transmittance. Advantageously channels 101 minimize the face area covered by concentrated, black, charged particles 11 in the open state by concentrating (or stacking) the particles in the z-axis of the cell 614.

In light modulator unit 449, each protrusion 795 is closely surrounded by its channel 101 and a polymer wall 76 and their extent define an electrophoretic ink cavity 488. In the FIG. 3B view, the black mask 606 covering polymer walls 76 is in peripheral areas of the apertures (i.e., it does not form part of an aperture's circumference) in the second light state with wall edges adjacent concentrated black particles 11 as shown by light obstruction dimension 1004. Advantageously, the black mask 606 covering walls 76 does not diffract light because along its circumference (in a face view), it does not coincide with a light transmitting area. In a related embodiment to 449, the channel 101 is absent and black charged particles 11 concentrate in the volume between the protrusion 795 and its surrounding wall 76 and adjacent the bottom electrode 60. More generally, it is advantageous in embodiments that polymer wall sections (or lengths in the face view) coincide with peripheral areas of protrusions so that in the open state, concentrated black charged particles are adjacent an edge of the wall section.

Preferably, the non-planar, polymer structure 158 is continuous in the cell 614 and isolates the electrophoretic ink layer 613 from the bottom electrode 60. Both the discrete apertures 1006 and the continuous light obstructing area 1004, that is the concentrated black charged particles area and the black mask area, are random, or possess a degree of randomness. To minimize or avoid the perception of a diffraction pattern arising from the black mask 606 on polymer walls 76, the arrangement of the polymer walls and the cavities 488 they form, are aperiodic.

In related embodiments to 449, the cavities, polymer walls and channels coincide with the extent of more than one microstructure. For example, each electrophoretic ink cavity, defined by its surrounding polymer walls 76, contains two or more protrusions with part of their extent coinciding with the walls, and each protrusion is surrounded by a channel.

The non-planar, polymer structure 158 in device 449 is derived from a photosensitive polymer (cured photoresist) exposed by a laser beam or electron beam (e-beam) and developed to reveal the surface of microstructures. Preferably each microstructure is independently written, asymmetrical, and randomly orientated. More preferably, the parameters that define each are uncorrelated, and the close-packing of microstructures and cavities has random centers.

The size of apertures and obstructions in embodiments is maximized to minimize their total circumference per square unit of face area. The upper limit is determined by the resolution of a typical viewer's eye. Preferably apertures and obstructions are sufficiently small that their geometric form in a face view is not apparent. In embodiments where the microstructures are protrusions and the black charged particles form discrete apertures in the open state, the maximum angle subtended by an aperture to a viewer at a required viewing distance is one arcminute (corresponding to 290 microns at a viewing distance of 1 meter) and preferably 0.6 arcminutes (corresponding to 174.5 microns at 1 meter). The subtended angle of the aperture pitch (i.e. aperture and concentrated charged particle area) is double these limits. In embodiments where the microstructures are recesses and the black charged particles form discrete obstructions in the second light state, the maximum angle subtended by an obstruction to a viewer at a required viewing distance is one arcminute (corresponding to about 290 microns at a viewing distance of 1 meter) and preferably 0.6 arcminutes (corresponding to about 174.5 microns at 1 meter). The subtended angle of the obstruction pitch (i.e. obstruction and light transmitting area) is double these limits.

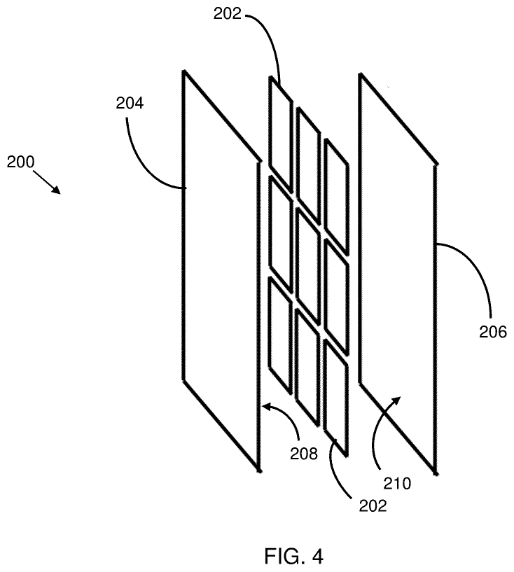

FIG. 4 is a simplified exploded view of an exemplary switchable large-area light modulator 200 constructed from a plurality of smaller individual light modulator units 202 in accordance with one or more embodiments. The individual light modulator units 202 are arranged side-by-side in an array. The array is then sandwiched between two large light-transmissive substrates 204 and 206, which are coated on their inner surfaces with light-transmissive electrode layers 208 and 210, respectively.

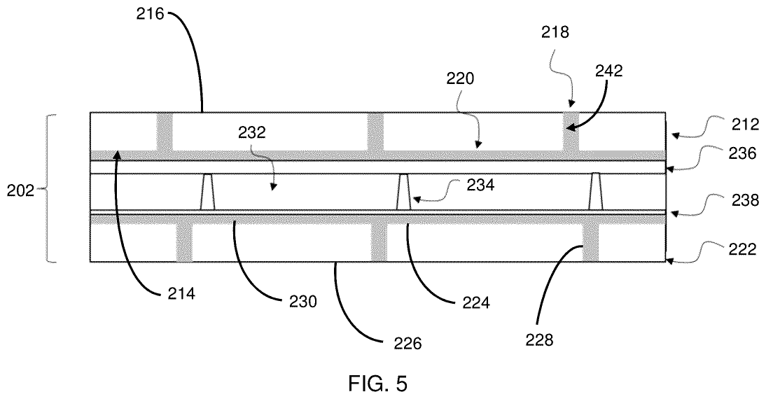

FIG. 5 is a simplified cross-section view of one of the individual light modulator units 202 in accordance with one or more embodiments. The light modulator unit 202 includes a first light-transmissive substrate 212 having opposite inner and outer surfaces 214, 216. The first light-transmissive substrate 212 has a plurality of electrically-conductive vias 218 extending between the inner and outer surfaces 214, 216. A first light-transmissive electrically-conductive layer 220 is disposed on the inner surface 214 of the first light-transmissive substrate 212 in electrical contact with the electrically-conductive vias 218.

The light modulator unit 202 also includes a second light-transmissive substrate 222 having opposite inner and outer surfaces 224, 226. The second light-transmissive substrate 222 also has a plurality of electrically-conductive vias 228 extending between the inner and outer surfaces 224, 226. A second light-transmissive electrically-conductive layer 230 is disposed on the inner surface 224 of the second light-transmissive substrate 222 in electrical contact with the electrically-conductive vias 228 of the second light-transmissive substrate 222.

In one or more embodiments, the electrically-conductive vias 218, 228 comprise through-holes 242 in the first and second light-transmissive substrates 212, 222 filled with an electrically-conductive material. This electrically conductive material is preferably light-transmissive, though this is not required.

As an alternative to the through-holes filled with conductive material, the vias 218, 228 may comprise conductive particles embedded at given locations in the substrates 212, 222. These particles may be aligned during an extrusion process used to make the substrates 212, 222.

The electrically-conductive vias 218, 228 form contact spots on the outer surfaces 216, 226 of the first and second light-transmissive substrates 212, 222. In one or more embodiments, the contact spots have an average diameter of at least 0.1 micrometers to at most 100 micrometers. In some embodiments, the contact spots have an average diameter of at least 25 micrometers to at most 100 micrometers. In some embodiments, the outer surfaces 216, 226 of the first and second light-transmissive substrates 212, 222 have an average density from at least 10 contact spots per square centimeter to at most 1000 contact spots per square centimeter. In some embodiments, the contact spots occupy less than 10% (and preferably less than 1%) of surface area of the outer surfaces 216, 226 of the first and second light-transmissive substrates 212, 222.

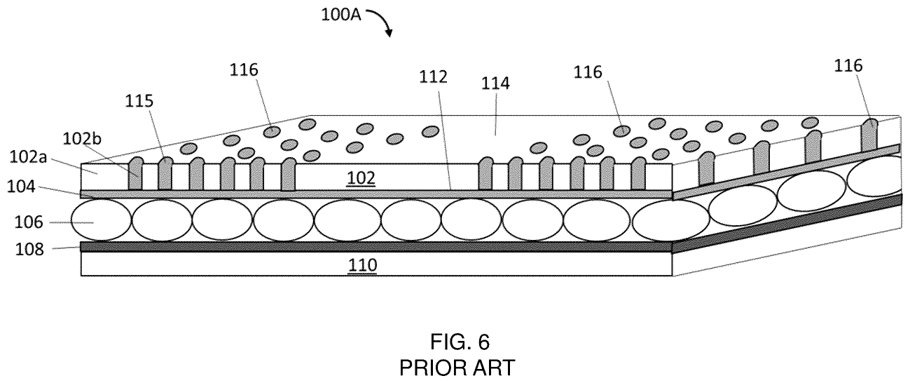

The electrically-conductive vias 218, 228 of the first and second light-transmissive substrates 212, 222 can be the same as or similar to the vias formed in an electrophoretic display disclosed in US 2022-0107541, which is incorporated by reference herein. FIG. 6, reproduced from US 2022-0107541, is described in that document as showing a front plane laminate 100A including a front plane light-transmissive substrate 102 having inner surface 112 and outer surface 114 opposite the inner surface 112. The front plane light-transmissive substrate 102 is a composite structure including a continuous portion 102a and a plurality of openings 102b, which are distributed within the continuous portion 102a. The openings 102b include an electrically-conductive material 115 forming electrical connections (vias) between the electrically-conductive layer 104 and one or more contact spots 116 on outer surface 114. The electrically-conductive layer 104 may be segmented in two or more sections, each section being in contact with a subset of the contact spots (not shown), giving rise to an architecture where a short circuit in one section will not result in a failure of the other sections, too. Electrical connections can be applied locally or to the entire outer surface, and a protective layer (not shown), e.g., a coat of a clear acrylic polymer or silicon, may be added to seal some or all the contact spots and provide a moisture barrier while preventing unwanted shorts after assembly. The continuous portion 102a may be may be manufactured from glass or a polymeric light-transmissive material, e.g., polyethylene terephthalate (PET), which is subjected to etching, cutting, laser ablation or any applicable perforation techniques to leave openings. Alternatively the continuous portion 102a may be micro-indented to create through-holes or valleys that can be filled during a sputtering process by which the conductive layer material, such as ITO, is added. Alternatively, PET films can be softened with heat, stretched over a form, and holes formed with jets of high-pressure gas. A conductive material may then be used to fill the openings, to form the contact spots 116. The openings may be provided in a variety of shapes, sizes, and densities to suit the application at hand. Irrespective of shape, individual and average spot sizes may be defined in terms of a given spot dimension. Unless otherwise provided or apparent from context, the term “dimension” means a length, width, or diameter of a contact spot along a surface of a layer. Typically, “length” means an extension in the longitudinal direction and width means an extension in the width direction. “Diameter”, when used in reference to a contact spot, is intended to identify the longest straight line segment between two points on the spot along the outer surface of the front plane light-transmissive substrate. In some non-exclusive embodiments, the geometry of the contact spots 116 is such that their average diameter falls in a range between about 0.1 μm to about 100 μm. In additional embodiments, the average contact spot diameter falls in a range between about 0.5 μm to about 10 μm.

Referring back to FIG. 5, an electro-optic medium layer 232 is disposed between and in contact with the first and second light-transmissive electrically-conductive layers 220, 230 such that the electro-optic medium can be addressed by driving voltages applied to the electrically-conductive layers 220, 230.

In one or more embodiments, the electro-optic medium layer 232 includes an encapsulated electrophoretic medium. In one or more embodiments, the electrophoretic medium is encapsulated in microcapsules or microcups. FIG. 5 shows a set of microcups defined by walls 234 formed by an embossing process. The microcups may be sealed using a layer 236 that makes contact with the first light-transmissive electrically-conductive layer. The electro-optic medium layer 232 further includes an optional primer layer 238 on the opposite side of the microcup structure.

The electrophoretic medium comprises charged pigment particles dispersed in a non-polar solvent. Application of a driving voltage causes the electrophoretic medium to switch between a first light-absorbing (i.e., closed) state and a second light-transmissive (i.e., open) state by moving between a distributed particle state and an assembled particle state, respectively.

In one or more embodiments, the electro-optic medium layer 232 further includes a polymeric structure (e.g., the polymeric structure 22 depicted in FIG. 2A or the polymeric structure 158 depicted in FIG. 3A) to guide movement of the charged pigment particles to the assembled particle state. The polymeric structure 22 includes a plurality of wells 32, wherein when the electro-optic medium is in the second light-transmissive state, the charged pigment particles are clustered in the wells 32 of the polymeric structure 22, and when the electro-optic medium is in the first light-absorbing state, the charged pigment particles are spread out over the polymeric structure, similar to the process shown in FIGS. 2B and 2C discussed above.

The electro-optic medium in each of the electro-optic units 202 is preferably bistable.

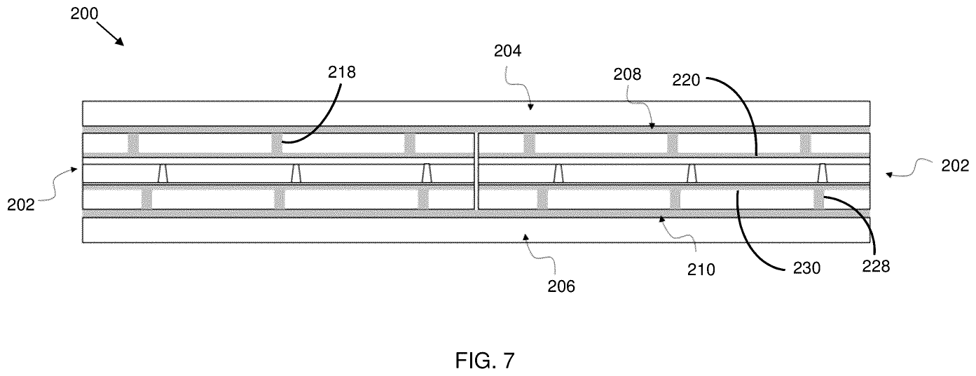

FIG. 7 is a simplified cross-section view of a portion of the light modulator 200 in accordance with one or more embodiments having two individual light modulator units 202 (depicted in FIG. 5). The light modulator units 202 are sandwiched between two larger light-transmissive substrates 204 and 206, which are coated on their inner surfaces with light-transmissive electrode layers 208 and 210, respectively. The light-transmissive electrode layers 208 and 210 are in electrical contact with vias 218, 228, respectively. In this way, the light-transmissive electrode layers 208 and 210 are electrically connected to the first and second light-transmissive electrically-conductive layers 220 and 230, respectively, of each of the individual light modulator units 202. This structure provides reliable and secure electrical connections to each of the individual light modulator units 202 without compromising the transparency of the light modulator 200 in the open state.

In one or more embodiments, the light-transmissive electrically-conductive layers 208, 210, 220, 230 comprise aluminum tin oxide, indium-tin-oxide (ITO), poly(3,4-ethylenedioxythiophene), or combinations thereof. The light-transmissive electrically-conductive layers 208, 210, 220, 230 may alternatively comprise an organic material such as PEDOT (poly-ethylenedioxythiophene). In addition, the light-transmissive electrically-conductive layers 208, 210, 220, 230 may comprise a composite material such as a matrix containing graphene or carbon nanotubes. The light-transmissive electrically-conductive layers 208, 210, 220, 230 may also comprise a sparse grid such as a printed grid or a nanowire formulation.

In one or more embodiments, each of the light transmissive substrates 204, 206, 212, 222 comprise polymers including acrylate, methacrylate, vinylbenzene, vinylether, urethanes, or multifunctional epoxides.

In one or more embodiments, the outer substrates 204 and 206 comprise any light-transmissive material of good optical quality that is resistant to scratching and able to protect other components from degradation caused by ingress of oxygen and water. In one or more embodiments, the light transmissive substrates 204, 206 comprise glass or a light-transmissive plastic material like poly(ethylene terephthalate), polycarbonate, or other polymeric materials as are well known in the art. In some embodiments, each substrate has a thickness of 25-100 micrometers.

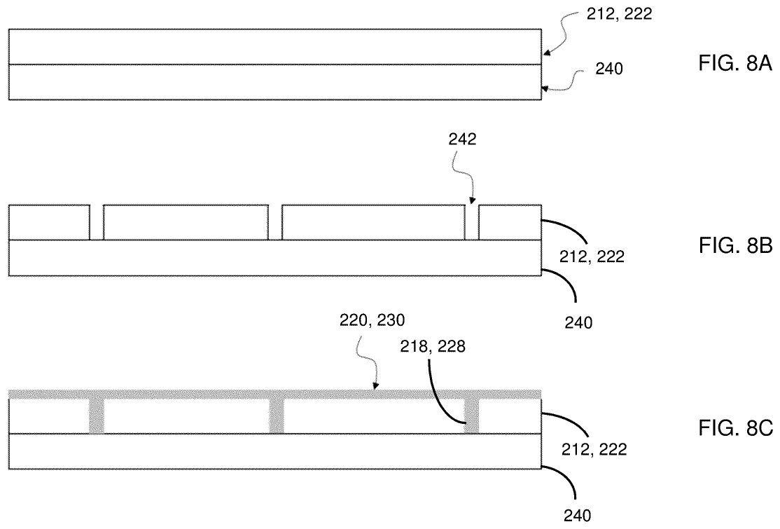

FIGS. 8A-8C illustrate an exemplary process of constructing a light-transmissive substrate 212, 222 and light-transmissive electrically-conductive layer 220, 230 for use in each light modulator unit 202 in accordance with one or more embodiments.

A light-transmissive plastic substrate 212, 222 is laminated to a removable liner 240 as shown in FIG. 8A. A plurality of through-holes 242 are formed through the substrate 212, 222 and to a depth that preferably does not completely penetrate through the liner 240 as shown in FIG. 8B. The holes 242 can be formed using a variety of processes including, e.g., laser drilling.

Next, as shown in FIG. 8C, the perforated substrate 212, 222 is coated with a light-transmissive conductive material that penetrates the drilled holes 242. This coating may be applied in a single pass or multiple passes. Preferably the material coated is 100% solid such that it does not shrink when drying. An example of a suitable material is a formulation comprising UV-curable monomers, in which conductive light-transmissive materials such as carbon nanotubes or graphene are dispersed. One example of a suitable conductive light-transmissive material is Tuball™ graphene nanotubes made by OCSiAl Corporation, Luxembourg.

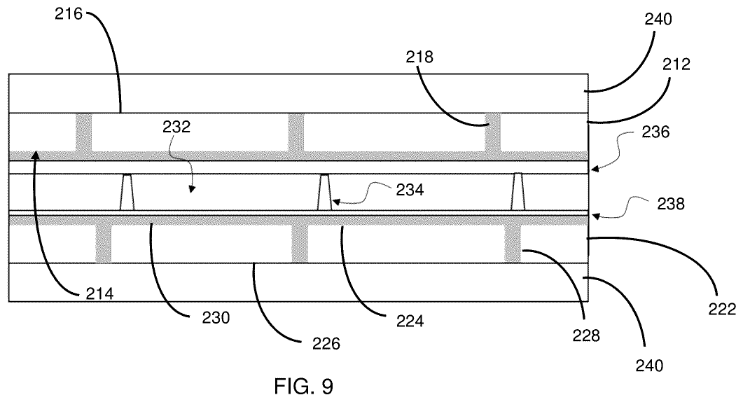

The process produces a light-transmissive substrate coated with a light-transmissive electrically-conductive layer. Two of these structures are used in the manufacture of each of the individual light modulator units 202, as shown in FIG. 9. Once the structures are assembled with the electro-optic medium layer 232, the release liners 240 are removed and the individual light modulator units 202 are arranged in an array and sandwiched between two larger light-transmissive substrates 204 and 206 coated with light-transmissive electrode layers 208 and 210 to form the light modulator shown in FIG. 7.

The light-transmissive electrode layers 208 and 210 can comprise the same material as the light-transmissive electrode layers 220 and 230, though this is not required. One preferred material for the electrode layers 208 and 210 is a UV-curable composition comprising a conductive light-transmissive filler such as graphene or carbon nanotubes. To assemble the structure shown in FIG. 7, the individual light modulator units 202 are laminated between the substrates 204 and 206 coated with the electrode layers 208 and 210, and the whole structure subsequently irradiated to cure the material 208 and 210.

The process thus enables a large-area light modulator 200 to be made from an array of smaller light modulator subunits 202 using conventional equipment without compromising optical transparency.

The light modulator 200 can regulate light transmission and/or visual access when incorporated into a window of a building, including single, double, and triple glazed windows. In the latter two, the light modulator is preferably located in a pane adjacent the outside environment so that absorbed sunlight energy can be dissipated by convection and thermal radiation to the outside environment. In other window and/or opening embodiments, the device regulates the transmission of sunlight into the interior of an automobile or public transport vehicle (e.g., bus, train, tram, ferry, or ship), minimizes glare, and provides a degree of privacy for occupants from outside viewers while maintaining visibility of the outside for occupants. Yet other embodiments include use as a light shutter, a light attenuator, a variable light transmittance sheet, a variable light absorptance sheet, a variable light reflectance sheet, a one-way mirror, a sunvisor, or a skylight.

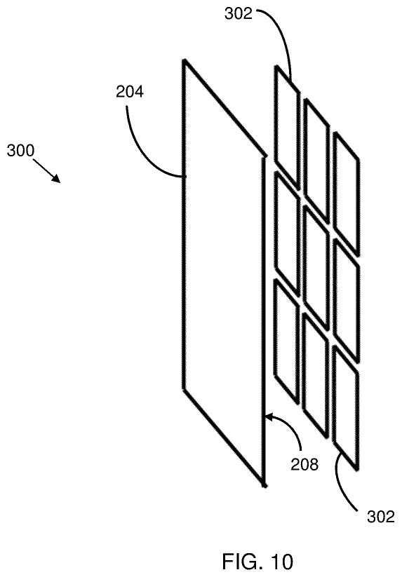

In addition to large-area electro-optic light modulators, the techniques disclosed herein can be applied to manufacturing large-area electro-optic displays. FIG. 10 is a simplified exploded view of an exemplary large-area light display 300 constructed from a plurality of smaller individual display units 302 in accordance with one or more embodiments. The individual display units 302 are arranged side-by-side in an array. A large light-transmissive substrate 204 coated on its inner surface with light-transmissive electrode layer 208 is superposed on the viewing surfaces of the array of display units. Unlike the large-area light modulators discussed above, only the viewing surfaces of the display units 302 are required to be covered by a light-transmissive substrate. The opposite surfaces of the display units 302 can be adhered to one or more backplane units for applying driving voltages to the electro-optic medium in the display units 302. The display units 302 each comprise a layer of electro-optic medium covered by a light-transmissive substrate coated with a light-transmissive electrically-conductive layer. The light-transmissive substrate has a plurality of electrically-conductive vias similar to the light-transmissive substrates 212, 222 having vias 218, 228 in the light-modulators discussed above. In this way, the light-transmissive electrically-conductive layer 208 can be connected to the array of display units 302 without compromising the transparency of the viewing surfaces of the displays.

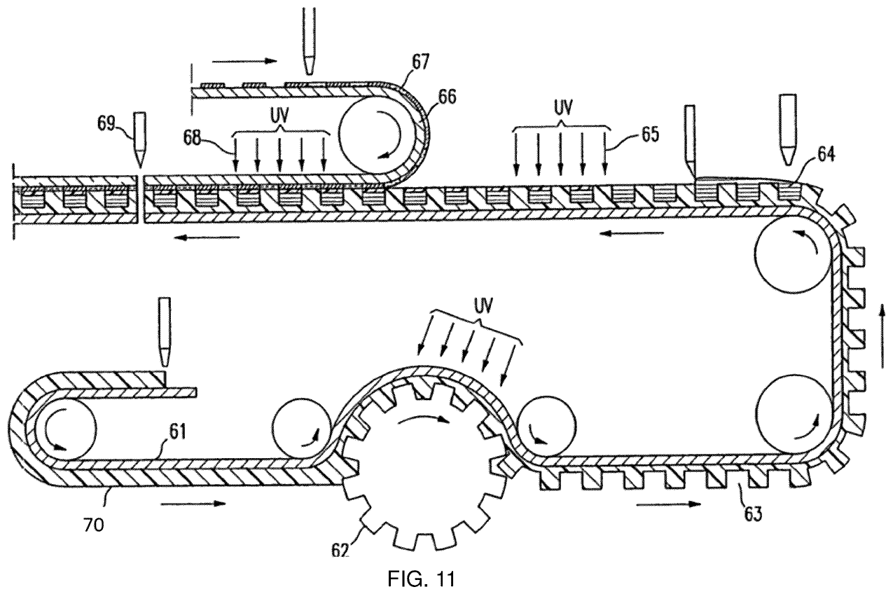

A electrophoretic film for use in each display unit 302 can be produced using a roll-to-roll process as illustrated in FIG. 11, similar to the process of producing a light-collimating film described in detail in U.S. Pat. No. 11,397,366, which is incorporated by reference herein. As shown in FIG. 11, the process involves a number of steps: In the first step a layer 70 of an embossing composition, e.g., a thermoplastic, thermoset, or a precursor thereof, optionally with a solvent, is deposited on a light-transmissive substrate 61. The light-transmissive substrate 61 is coated with a conductive layer and includes an array of electrically-conductive vias similar to substrates 212, 222. (The solvent, if present, readily evaporates.) A primer layer (i.e., an electrode protection layer) may be used to increase the adhesion between the layer of embossing composition and the supporting layer, which may be the PET. Additionally, an adhesion promoter may be used in the primer layer to improve adhesion to the supporting layer. In the second step, the layer 70 is embossed at a temperature higher than the glass transition temperature of the layer material by a pre-patterned embossing tool 62. (The primer and/or adhesion promoter may be adjusted to decrease adhesion to the embossing tool 62. In the third step, the patterned layer 70 is released from the embossing tool 62 preferably during or after it is hardened, e.g., by cooling. The characteristic pattern of the elongated chambers (as described above) is now established. In step four, the elongated chambers 63 are filled with a bistable electrophoretic fluid 64. In some embodiments, the bistable electrophoretic fluid will include a sealing composition that is incompatible with the electrophoretic fluid 64 and has a lower specific gravity than the solvent and the pigment particles in the electrophoretic fluid 64. In such embodiments, the sealing composition will rise to the top of the elongated chambers 63, whereby it can be hardened in subsequent steps. As an alternative (not shown in FIG. 11), the sealing composition may be overcoated after the elongated chambers 63 are filled with the electrophoretic fluid 64. In the next step, the elongated chambers 63 filled with electrophoretic fluid 64 are sealed by hardening the sealing composition, e.g., with UV radiation 65 or by heat or moisture. In the sixth step, the scaled elongated chambers are laminated to a second transparent conductive film 66, which may be pre-coated with an optically clear adhesive layer 67, which may be a pressure sensitive adhesive, a hot melt adhesive, a heat, moisture, or radiation curable adhesive. Preferred materials for the optically-clear adhesive include acrylics, styrene-butadiene copolymers, styrene-butadiene-styrene block copolymers, styrene-isoprene-styrene block copolymers, polyvinylbutyal, cellulose acetate butyrate, polyvinylpyrrolidone, polyurethanes, polyamides, ethylene-vinylacetate copolymers, epoxides, multifunctional acrylates, vinyls, vinylethers, and their oligomers, polymers, and copolymers. In the final step the finished sheets may be cut, e.g., with a knife edge 69, or with a laser cutter. In some embodiments, an eighth step, including laminating another optically-clear adhesive and a release sheet may be performed on the finished film so that it can be shipped in section sheets or rolls and cut to size when it is to be used, e.g., for incorporation into a display or other device/substrate.

It will be apparent to those skilled in the art that numerous changes and modifications can be made in the specific embodiments of the present invention described above without departing from the scope of the invention. Accordingly, the whole of the foregoing description is to be construed in an illustrative and not in a limitative sense.

1. An electro-optic device, comprising:
(a) a plurality of electro-optic units in a side-by-side tiled arrangement, each of said electro-optic units comprising:
a first light-transmissive substrate having opposite inner and outer surfaces, said first light-transmissive substrate having a plurality of electrically-conductive vias extending between the inner and outer surfaces;
a first light-transmissive electrically-conductive layer on the inner surface of the first light-transmissive substrate in electrical contact with the electrically-conductive vias of the first light-transmissive substrate;
a second light-transmissive substrate having opposite inner and outer surfaces, said second light-transmissive substrate having a plurality of electrically-conductive vias extending between the inner and outer surfaces of the second light-transmissive substrate;
a second light-transmissive electrically-conductive layer on the inner surface of the second light-transmissive substrate in electrical contact with the electrically-conductive vias of the second light-transmissive substrate; and
an electro-optic medium layer between and in contact with the first and second light-transmissive electrically-conductive layers;
(b) a third light-transmissive substrate superposed on the outer surfaces of the first light-transmissive substrates of each of the plurality of electro-optic units;
(c) a third light-transmissive electrically-conductive layer between the third light-transmissive substrate and the plurality of electro-optic units, said third light-transmissive electrically-conductive layer being in electrical contact with the electrically-conductive vias of the first light-transmissive substrates of each of the plurality of electro-optic units;
(d) a fourth light-transmissive substrate superposed on the outer surfaces of the second light-transmissive substrates of each of the plurality of electro-optic units; and
(e) a fourth light-transmissive electrically-conductive layer between the fourth light-transmissive substrate and the plurality of electro-optic units, said fourth light-transmissive electrically-conductive layer being in electrical contact with the electrically-conductive vias of the second light-transmissive substrates of each of the plurality of electro-optic units.

2. The electro-optic device of claim 1, wherein the electro-optic medium layer in each of the electro-optic units comprises an encapsulated electrophoretic medium.

3. The electro-optic device of claim 1, wherein the electro-optic device is a switchable light modulator, and wherein the electro-optic medium in each of the electro-optic units comprises charged pigment particles dispersed in a non-polar solvent, and the electro-optic medium switches between a first light-absorbing state and a second light-transmissive state by moving between a distributed particle state and an assembled particle state.

4. The electro-optic device of claim 1, wherein the first, second, third, or fourth light-transmissive substrates comprise polymers including acrylate, methacrylate, vinylbenzene, vinylether, urethanes, or multifunctional epoxides, and/or wherein the first, second, third, or fourth light-transmissive electrically-conductive layers comprise (a) a material selected from the group consisting of aluminum tin oxide, indium-tin-oxide, poly(3,4-ethylenedioxythiophene), and combinations thereof, (b) an organic material, (c) a composite material, or (d) a sparse grid.

5. The electro-optic device of claim 1, wherein the electrically-conductive vias in the first and second light-transmissive substrates form contact spots on the outer surfaces thereof, wherein the contact spots have an average diameter of at least 0.1 micrometers to at most 100 micrometers.

6. The electro-optic device of claim 1, wherein the electrically-conductive vias occupy less than 10% of surface area of the outer surfaces of the first and second light-transmissive substrates.

7. A window including the electro-optic device according to claim 1.

8. A method of manufacturing an electro-optic device, comprising the steps of:
(a) providing a plurality of electro-optic units, each of said electro-optic units comprising:
a first light-transmissive substrate having opposite inner and outer surfaces, said first light-transmissive substrate having a plurality of electrically-conductive vias extending between the inner and outer surfaces;
a first light-transmissive electrically-conductive layer on the inner surface of the first light-transmissive substrate in electrical contact with the electrically-conductive vias of the first light-transmissive substrate;
a second light-transmissive substrate having opposite inner and outer surfaces, said second light-transmissive substrate having a plurality of electrically-conductive vias extending between the inner and outer surfaces of the second light-transmissive substrate;
a second light-transmissive electrically-conductive layer on the inner surface of the second light-transmissive substrate in electrical contact with the electrically-conductive vias of the second light-transmissive substrate; and
an electro-optic medium layer between and in contact with the first and second light-transmissive electrically-conductive layers;
(b) positioning the plurality of electro-optic units in a side-by-side tiled arrangement; and
(c) laminating a third light-transmissive substrate covered by a third light-transmissive electrically-conductive layer on one side of the plurality of electro-optic units and a fourth light-transmissive substrate covered by a fourth light-transmissive electrically-conductive layer on an opposite side of the plurality of electro-optic units,
wherein the third light-transmissive substrate is superposed on the outer surfaces of the first light-transmissive substrates of each of the plurality of electro-optic units, and the third light-transmissive electrically-conductive layer is disposed between the third light-transmissive substrate and the plurality of electro-optic units, said third light-transmissive electrically-conductive layer being in electrical contact with the electrically-conductive vias of the first light-transmissive substrates of each of the plurality of electro-optic units;
wherein the fourth light-transmissive substrate is superposed on the outer surfaces of the second light-transmissive substrates of each of the plurality of electro-optic units, and the fourth light-transmissive electrically-conductive layer is disposed between the fourth light-transmissive substrate and the plurality of electro-optic units, said fourth light-transmissive electrically-conductive layer being in electrical contact with the electrically-conductive vias of the second light-transmissive substrates of each of the plurality of electro-optic units.

9. The method of claim 8, wherein step (a) includes (i) forming holes in the first light-transmissive substrate and depositing a conductive material on the inner surface of the first light-transmissive substrate to form the first light-transmissive electrically-conductive layer and the electrically-conductive vias; and (ii) forming holes in the second light-transmissive substrate and depositing the conductive material on the inner surface of the second light-transmissive substrate to form the a second light-transmissive electrically-conductive layer and the electrically-conductive vias.

10. The method of claim 9, wherein forming the holes in the first and second light-transmissive substrates comprises drilling the holes using a laser.

11. The method of claim 9, wherein the conductive material comprises conductive transparent materials dispersed in a UV-curable monomer.

12. The method of claim 8, wherein the third and fourth light-transmissive electrically-conductive layers comprise conductive transparent materials dispersed in a UV-curable monomer.

13. The method of claim 12, wherein step (c) further comprises irradiating the third and fourth light-transmissive electrically-conductive layers to cure the UV-curable monomer.

14. The method of claim 8, wherein the electro-optic medium layer in each of the electro-optic units comprises an encapsulated electrophoretic medium.

15. An electro-optic device, comprising:
(a) a plurality of electro-optic units in a side-by-side tiled arrangement, each of said electro-optic units comprising, in order:
a first light-transmissive substrate having opposite inner and outer surfaces, said first light-transmissive substrate having a plurality of electrically-conductive vias extending between the inner and outer surfaces;
a first light-transmissive electrically-conductive layer on the inner surface of the first light-transmissive substrate in electrical contact with the electrically-conductive vias of the first light-transmissive substrate;
an electro-optic medium layer in contact with the first light-transmissive electrically-conductive layer; and
a backplane comprising at least one electrode;
(b) a second light-transmissive substrate superposed on the outer surfaces of the first light-transmissive substrates of each of the plurality of electro-optic units; and
(c) a second light-transmissive electrically-conductive layer between the second light-transmissive substrate and the plurality of electro-optic units, said second light-transmissive electrically-conductive layer being in electrical contact with the electrically-conductive vias of the first light-transmissive substrates of each of the plurality of electro-optic units.

16. The electro-optic device of claim 15, wherein the electro-optic medium layer in each of the electro-optic units comprises an encapsulated electrophoretic medium.

17. The electro-optic device of claim 16, wherein the first or second light-transmissive substrates comprise polymers including acrylate, methacrylate, vinylbenzene, vinylether, urethanes, or multifunctional epoxides, and/or wherein the first or second light-transmissive electrically-conductive layers comprise (a) a material selected from the group consisting of aluminum tin oxide, indium-tin-oxide, poly(3,4-ethylenedioxythiophene), and combinations thereof, (b) an organic material, (c) a composite material, or (d) a sparse grid.

18. The electro-optic device of claim 15, wherein the electrically-conductive vias in the first light-transmissive substrate form contact spots on the outer surface thereof, wherein the contact spots have an average diameter of at least 0.1 micrometers to at most 100 micrometers.

19. The electro-optic device of claim 15, wherein the outer surface of the first light-transmissive substrate has an average density from at least 10 contact spots per square centimeter to at most 1000 contact spots per square centimeter.

20. The electro-optic device of claim 15, wherein the electrically-conductive vias occupy less than 10% of surface area of the outer surface of the first light-transmissive substrate.
